(19) United States
(12) Patent Application Publication
(10) Pub. No.: US 2020/0392312 A1
(43) Pub. Date: Dec. 17, 2020

(54) ELASTOMER COMPOSITION COMPRISING PRECIPITATED SILICA AND A SULFUR-CONTAINING AROMATIC POLYMER

(71) Applicant: RHODIA OPERATIONS, Paris (FR)

(72) Inventors: Thomas CHAUSSEE, Cailloux-sur-Fontaines (FR); Cédric BOIVIN, Chasselay (FR); Patrizia MACCONE, Milano (IT)

(21) Appl. No.: 16/636,637

(22) PCT Filed: Jul. 31, 2018
(86) PCT No.: PCT/EP2018/070677

§ 371 Date: Feb. 4, 2020

(30) Foreign Application Priority Data
Aug. 4, 2017 (EP) 17306043.5

(51) Int. Cl. C08L 9/06; C08J 3/20; B60C 1/00; B60C 11/00

(52) U.S. Cl. CPC C08L 9/06; C08J 3/203; B60C 2011/0025; B60C 11/0008; B60C 1/0016

(57) ABSTRACT

The present invention relates to an elastomer composition comprising silica and a sulfur-containing aromatic polymer which has improved handling and ease of manufacture. The invention also relates to a process for the preparation of elastomer composition and to an article comprising the same.

This application claims priority to European application EP 17306043.5, filed on Apr. 8, 2017, the whole content of this application being incorporated herein by reference for all purposes.

### TECHNICAL FIELD

The present invention relates to an elastomer composition, especially intended for the manufacture of tires or semi-finished products for tires, having improved processability and ease of manufacture.

The invention also relates to a process for the preparation of said composition and to a tire or tire component comprising the same.

### BACKGROUND ART

Tires are subjected to numerous stresses during use. Tire treads in particular must respond to a large number of often conflicting technical requirements, including low rolling resistance and good dry and wet grip. The mixtures for these tires must also have good processability, that is to say they must be easy to manufacture.

The use of fillers such as precipitated silica in elastomeric mixtures, such as tire tread mixtures, has been known for a long time. Such use is highly demanding: the filler has to readily and efficiently incorporate and disperse in the elastomeric composition and, typically in conjunction with a coupling reagent, enter into a chemical bond with the elastomer(s), to lead to a high and homogeneous reinforcement of the elastomeric composition. In the case of high performance tires, precipitated silica is used in order to achieve good properties with regard to wet skidding, rolling resistance, handling and abrasion performance.

Sulfur-containing aromatic polymer such as polyarylene sulfides and polyarylsulfones are thermally stable engineering plastics consisting mainly of phenyl or biphenyl groups linked by sulfide, ether and/or sulfone groups. Those materials have excellent heat resistance and chemical resistance.

JP 2014/062141 A discloses a rubber composition for a tire which comprises 100 parts by mass of a diene rubber (A), 30 to 100 parts by mass of carbon black and/or white filler (B), 0.3 to 30 parts by mass of a crosslinkable oligomer or polymer (C), and 0.1 to 12 parts by mass of polysulfide-based three-dimensionally crosslinked fine particles (D) having an average particle diameter of 1 to 200 μm. The polysulfide-based three-dimensionally crosslinked fine particles (D) disclosed in the application do not contain repeating units based on aromatic moieties.

EP 1344796 A1 discloses a rubber composition for a tire sidewall containing a thermoplastic polymer which comprises at least one diene-based elastomer and an inclusion therein of said thermoplastic polymer is provided which comprises, based upon 100 phr of elastomer: (A) 100 phr of a diene-based elastomer, and (B) about 5 to about 20 phr of particulate thermoplastic material dispersed therein selected from at least one of polyphenylene ether, polyphenylene sulfide and syndiotactic polystyrene or mixtures thereof, (C) about 20 to about 100 phr of at least one reinforcing particulate filler selected from carbon black, aggregates of synthetic amorphous silica and silica-containing carbon having domains of silica on its surface, and (D) a coupling agent. EP 1344796 A1 does not explicitly disclose compositions comprising an elastomer, a sulfur-containing aromatic polymer and silica.

WO 2004/005395 A2 discloses a method for increasing the hardness of silica/rubber mixtures which comprises blending the silica/rubber mixture with at least one silane and at least one hardness increasing amount of a fourth component. Said fourth component may be, among others, a thermoplastic resin which can be a poly(phenylene sulfide). WO 2004/005395 A2 does not explicitly disclose compositions comprising an elastomer, a sulfur-containing aromatic polymer and silica.

### SUMMARY OF INVENTION

The Applicant has surprisingly found that the use of certain sulfur-containing aromatic polymers allows to improve the handling and processability of elastomeric compositions, in particular silica-filled elastomeric compositions, without compromising other properties.

Additionally it has been found that an improvement in tire properties like dry and wet grip can be expected without negatively impacting rolling resistance.

It is thus a first objective of the present invention to provide an elastomer composition which is provided with good handling and processability properties.

Another objective of the present invention is to provide a process for preparing the elastomer composition.

In a further objective, the present invention is directed to articles, in particular tires, comprising said elastomer composition.

### DESCRIPTION OF INVENTION

First object of the present invention is an elastomer composition (C) comprising:
an elastomer (E),
a sulfur-containing aromatic polymer [aromatic polymer (A)], and
silica (S).

Elastomer (E)

In the present specification, the term elastomer is used in the meaning provided by IUPAC to indicate a “polymer that displays rubber-like elasticity”, that is a polymer which readily undergoes deformation and exhibits large reversible elongations under small applied stress. Elastomer (E) preferably exhibits at least one glass transition temperature (Tg), measured by differential scanning calorimetry (DSC) of between −150° C. and +300° C., for example between −150° C. and +20° C.

In the description of this invention, the terms “rubber” and “elastomer” may be used interchangeably.

Elastomer (E) is selected from the group consisting of diene elastomers, that is elastomers comprising recurring units derived at least in part from diene monomers, that is to say, monomers bearing two carbon-carbon double bonds, whether conjugated or not.

Notable, non-limiting examples of suitable diene elastomers, are for instance:

(a) polymers comprising recurring units derived from at least one conjugated diene monomer having 4 to 12 carbon atoms;

(b) polymers comprising recurring units derived from one or more dienes conjugated together or from one or more vinyl-aromatic compounds having 8 to 20 carbon atoms;

(c) ternary copolymers comprising recurring units derived from ethylene, an α-olefin having 3 to 6 carbon atoms and a non-conjugated diene monomer having 6 to 12 carbon atoms, such as, for example, the elastomers obtained from ethylene, propylene and a non-conjugated diene monomer of the aforementioned type, such as in particular 1,4-hexadiene, ethylidene norbornene or dicyclopentadiene;

(d) polymers comprising recurring units derived from isobutene and isoprene (butyl rubber), and also the halogenated, in particular chlorinated or brominated, versions thereof.

The expression “copolymer” is used herein to refer to polymers comprising recurring units deriving from at least two monomeric units of different nature.

Suitable conjugated dienes are, for instance, 1,3-butadiene, 2-methyl-1,3-butadiene, 2,3-di(C₁-C₅alkyl)-1,3-butadienes such as, for instance, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene and 2,4-hexadiene.

Suitable vinyl-aromatic compounds are, for example, styrene, ortho-, meta- and para-methylstyrene, the commercial mixture “vinyltoluene”, para-tert-butylstyrene, methoxystyrenes, chlorostyrenes, vinylmesitylene, divinylbenzene and vinylnaphthalene.

The elastomers may have any microstructure, which is a function of the polymerisation conditions used, in particular of the presence or absence of a modifying and/or branching agent and the quantities of modifying and/or branching agent used. The elastomers may for example be block, statistical, sequential or microsequential elastomers, and may be prepared in a dispersion or in solution; they may be coupled and/or starred or alternatively functionalized with a coupling and/or starring or functionalizing agent.

Among diene elastomers mention may be made, for example, of polybutadienes (BRs), polyisoprenes (IRs), butadiene copolymers, isoprene copolymers, or their mixtures, and in particular styrene/butadiene copolymers (SBRs, in particular ESBRs (emulsion) or SSBRs (solution)), isoprene/butadiene copolymers (BIRs), isoprene/styrene copolymers (SIRs), isoprene/butadiene/styrene copolymers (SBIRs), ethylene/propylene/diene terpolymers (EPDMs), and also the associated functionalized polymers (exhibiting, for example, pendant polar groups or polar groups at the chain end, which can interact with the silica).

Mention may also be made of natural rubber (NR) and epoxidized natural rubber (ENR).

Elastomer (E) may consist of one single elastomer as detailed above or it may comprise a mixture of more than one elastomers.

Aromatic Polymer (A)

Aromatic polymer (A) to be used in the present invention may be a poly(arylene sulfide) or an aromatic sulfone polymer.

Poly(arylene sulfide)s are polymers comprising the repeating unit of the formula -(Ar-S)- as the main structural unit, preferably containing the repeating unit in an amount of 80 mol % or more. Ar represents an aromatic group, and examples include units (RU1) represented by the formulas (I) to (XI) given below, among which the formula (I) is particularly preferred:

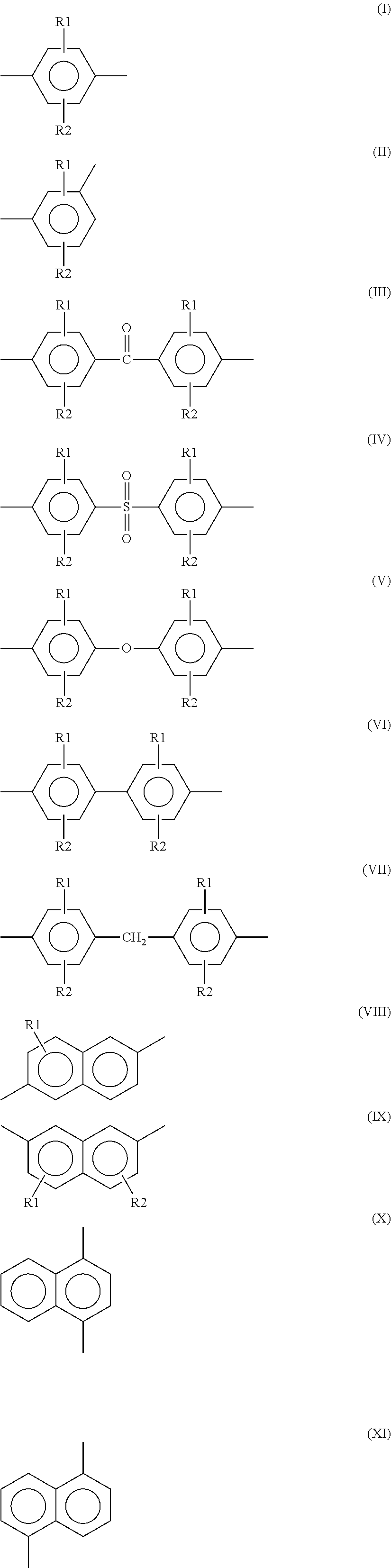

wherein R1 and R2 each represent a substituent selected from hydrogen, alkyl of 1 to 12 carbon atoms, alkoxy of 1 to 12 carbon atoms, arylene of 6 to 24 carbon atoms, and halogen, and R1 and R2 may be the same or different.

Poly(arylene sulfide) is preferably poly(phenylene sulfide) (PPS).

Poly(phenylene sulfide) is notably available as Ryton® PPS from Solvay Specialty Polymers USA, L.L.C.

Suitable poly(phenylene sulfide) polymers for use in the inventive compositions are for instance those characterised by a melt flow rate, measured at 316° C. under a 5.0 kg load, from 100 to 1600 g/10 min. Melt flow rates are measured according to ASTM method D1238, procedure B.

The poly(phenylene sulfide) may advantageously have a melt flow rate (316° C./5.0 kg) from 100 to 1000 g/10 min, even from 100 to 800 g/10 min, preferably from 100 to 500 g/100 min.

The poly(phenylene sulfide) may alternatively have a melt flow rate (316° C./5.0 kg) from 500 to 1600 g/10 min, even from 600 to 1500 g/10 min.

The poly(phenylene sulfide) may be characterised by a glass transition temperature, Tg, measured using differential scanning calorimetry according to ISO 11357-2, in the range from 70 to 110° C., preferably from 80 to 100° C.

Notable non-limiting examples of poly(phenylene sulfide) polymers having the features detailed above are for instance Ryton® QA200N, Ryton® QA220N, Ryton®QA281N and Ryton®QA321N all available from Solvay Specialty Polymers USA, L.L.C.

Aromatic polymer (A) may be an aromatic sulfone polymer. For the purposes of the present invention, the definition “aromatic sulfone polymer” is intended to denote any polymer of which more than 50 wt %, preferably more than 70 wt %, more preferably more than 90 wt %, of recurring units (RU2) comprise at least one group of formula (XII):

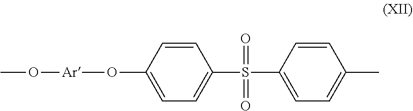

Ar′ being a group chosen among the following structures:

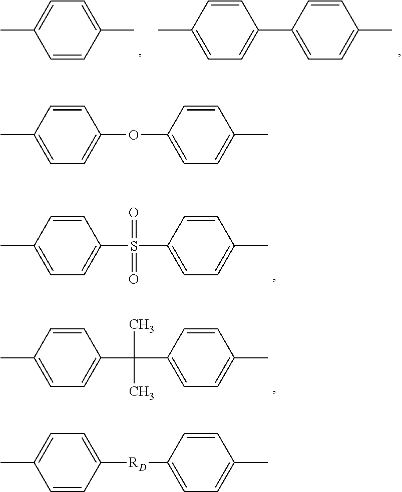

with RD being:

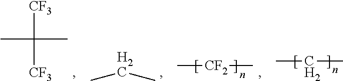

with n=integer from 1 to 6.

The recurring units (RU2) are preferably chosen from:

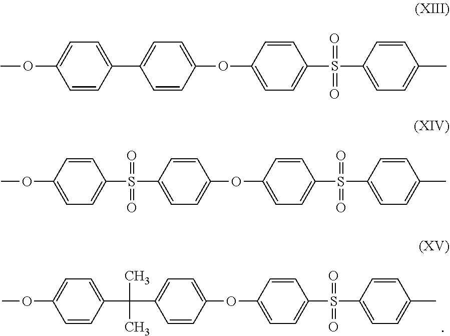

The aromatic sulfone polymer is preferably chosen among the group consisting of polysulfone (PSU), polyphenylsulfone (PPSU), polyethersulfone (PESU), copolymers and mixtures thereof and is most preferably a polysulfone (PSU) or polyphenylsulfone (PPSU).

Polysulfone is notably available as UDEL® PSU from Solvay Specialty Polymers USA, L.L.C.

Polysulfone is made by condensing bisphenol A and 4,4′-dichlorodiphenyl sulfone.

Polyphenylsulfone is notably available as RADEL® R from Solvay

Specialty Polymers USA, L.L.C and is made by reacting units of 4,4′-dichlorodiphenyl sulfone and 4,4′-biphenol.

Methods well known in the art for the preparation of polyphenylsulfone are for instance those described in documents U.S. Pat. Nos. 3,634,355; 4,008,203; 4,108,837 and 4,175,175, the whole content of which is incorporated herein by reference.

Silica (S)

The term “silica” is used herein to identify amorphous silicon dioxide SiO₂.

Notable examples are colloidal silica, pyrogenic silica and precipitated silica. Silica (S) is preferably precipitated silica (PS).

The expression “precipitated silica” is used herein to identify silica which has been obtained by precipitation from a solution containing silicate salts (such as sodium silicate), with an acidifying agent (such as sulfuric acid). Notable non-limiting examples of processes for the preparation of precipitated silica are for instance those disclosed in EP396450A, EP520862A, EP670813A, EP670814A, EP762992A, EP762993A, EP917519A, EP1355856A, WO03/016215, WO2009/112458, WO2011/117400, WO2013/110659, WO2013/139934, WO2008/000761.

Precipitated silica (PS) has a BET specific surface (SBET) in the range from 45 m²/g to 550 m²/g. BET specific surface SBET is typically at least 70 m²/g and preferably of at least 80 m²/g. The BET specific surface SBET may be even of at least 100 m²/g, preferably of at least 120 m²/g, and more preferably of at least 130 m²/g.

The BET specific surface S_{BET} generally is at most 500 m²/g, in particular at most 370 m²/g, and even at most 350 m²/g. The BET specific surface is determined according to the Brunauer-Emmett-Teller method as detailed in standard NF ISO 5794-1, Appendix E (June 2010).

In general, precipitated silica (PS) has a CTAB specific surface (ScTAB) in the range from 40 m²/g to 525 m²/g. CTAB specific surface S_{CTAB} is at least 60 m²/g, preferably of at least 80 m²/g. The CTAB specific surface S_{CTAB} generally is at most 400 m²/g, especially at most 350 m²/g. The CTAB specific surface provides a measure of the external surface of the silica. It can be determined according to standard NF ISO 5794-1, Appendix G (June 2010).

Precipitated silica (PS) may have a ratio S_{BET}/S_{CcTAB} of 0.9 to 1.2. In alternative embodiments precipitated silica (PS) has a ratio S_{BET}/S_{CTAB} greater than 1.3, even up to 2.5.

In some embodiments precipitated silica (PS) has a a pore volume distribution V₂/V₁, as defined hereafter, of at most 0.5, preferably in the range of from 0.15 to 0.49, more preferably in the range of from 0.19 to 0.35.

As examples of precipitated silica which could be used in the present invention, mention may be made of commercial silicas, in particular precipitated silica such as Zeosil® 1165MP, Zeosil® 1115MP, Zeosil® Premium 200MP, Zeosil® 1085GR, Zeosil® 195HR, Zeosil® 165GR, Zeosil® 115GR, Zeosil® HRS 1200MP, Zeosil® 195GR, Zeosil® 185GR, Zeosil® 175GR, Zeosil® 125GR, Zeosil® Premium 200, Zeosil® Premium SW (all commercially available from Solvay), Ultrasil® 5000GR, Ultrasil® 7000GR, Ultrasil® 9000GR, Ultrasil® VN3GR, Hi-Sil® EZ 160G-D, Hi-Sil® EZ 150G, Hi-Sil® 190G, Hi-Sil® 200G-D, Hi-Sil® HDP-320G, Hi-Sil® 255CG-D, Zeopol® 8755LS, Zeopol® 8745, Newsil® 115GR, Newsil® 2000MP, Tokusil® 315.

In a first embodiment, precipitated silica (PS) is characterised by:
a BET specific surface area SBET from 190 to 320 m²/g,
a CTAB specific surface area S_{CTAB} from 170 to 300 m²/g,
a width of the particle size distribution Ld of at least 0.91, preferably from 1.00 to 3.00, more preferably from 1.00 to 2.00; and
a pore volume distribution such that the ratio V_{(d5-d50)}/V_{(d5-d100)} is at least 0.65, especially from 0.65 to 0.75.

Parameter Ld is used to characterize the width of the particle size distribution. Ld is defined as follows:

Ld=(d84-d16)/d50

wherein do is the particle diameter below which n% of the total measured mass is found. Ld is an adimensional number. The width of the particle size distribution Ld is calculated on the cumulative particle size curve. As an example, d50 represents the particle diameter below (and above) which 50% of the total mass of particles is found. Thus, d50 represents the median particle size of a given distribution, wherein the term “size” in this context has to be intended as “diameter”. Parameter Ld is measured by XDC particle size analysis after ultrasound deagglomeration according to the method detailed in WO03/016215 from page 7, line 15 to page 8, line 24, said method is incorporated herein by reference.

The pore volumes and pore diameters are typically measured by mercury

(Hg) porosimetry using a Micromeritics Autopore 9520 porosimeter and are calculated by the Washburn relationship with a contact angle theta equal to 130° and a surface tension gamma equal to 484 dynes/cm (standard DIN 66133). Each sample is pre-dried in an oven at 200° C. for 2 hours before measurement is carried out.

The pore volume distribution V₂/V₁ represents the ratio of the pore volume generated by the pores having a diameter of between 175 and 275 Å (V₂) to the pore volume generated by the pores having diameters of less than or equal to 400 Å (V₁). V_{(d5-d50)} represents the pore volume consisting of pores between d5 and d50 in diameter, and V_{(d5-d100)} represents the pore volume consisting of pores between d5 and d100 in diameter, do being here the pore diameter for which n% of the total surface area of all the pores is provided by the pores with a diameter greater than this diameter (the total surface area of the pores (So) may be determined from the mercury intrusion curve). The derivative of the cumulative curve (cumulative pore volume (mL/g)) as a function of the pore radius (nm) gives a frequency curve; the value (in nm) of the maximum of this curve for pores with radii of less than 100 nm is known as the “Mode” of the pore size distribution.

In a second embodiment, precipitated silica (PS) is characterised by:
a CTAB specific surface area S_{CTAB} from 60 to 400 m²/g, preferably from 100 to 200 m²/g;
a median particle size d50 such that:

|d50|>(6214/|S_{CTAB}|)+23
a pore volume distribution such that:

V_{(d5-d50)}/V_{(d5-d100)}>0.906−(0.0013×|S_{CTAB}|), and
a pore size distribution such that:

|Model>(4166/|S_{CTAB}|)−9.2,

wherein |d50| represents the numerical value of the median particle size d50 as defined above and expressed in nm; |S_{CTAB}| represents the numerical value of the CTAB surface area S_{CTAB} expressed in m²/g; and |Mode| represents the numerical value of the Mode of the pore size distribution as defined above and expressed in nm. A silica having the features above detailed is disclosed in WO2009/112458 A1 whose content is incorporated herein by reference.

The physical state under which silica (S) is provided is not important, whether it is in the form of a powder, of microbeads, of granules or any other appropriate form.

The expressions silica (S) or “precipitated silica (PS)” are also understood to mean mixtures of different silicas or precipitated silicas, in particular of highly dispersible precipitated silicas.

Composition (C)

Unless stated otherwise all compositions are defined in terms of parts by weight of a given ingredient per 100 parts of the sum of all of the elastomer (E) in the composition, the quantity above being identified by the symbol “phr”.

Advantageously composition (C) comprises:
elastomer (E),
from 10 to 200 phr of silica (S), preferably precipitated silica (PS), and
from 0.5 to 50 phr of aromatic polymer (A).

Aromatic polymer (A) is preferably present in an amount of 1 to 40 phr, preferably 1 to 20 phr, even 1 to 15 phr.

Preferably, composition (C) comprises:
elastomer (E),
from 50 to 150 phr of precipitated silica (PS), and
from 1 to 40 phr of aromatic polymer (A).

More preferably, composition (C) comprises:
elastomer (E),
from 60 to 120 phr of precipitated silica (PS), and
from 1 to 20 phr of aromatic polymer (A).

Aromatic polymer (A) is preferably present in an amount of 1 to 15 phr.

Aromatic polymer (A) is preferably poly(phenylene sulfide).

In a first embodiment of the invention, composition (C) comprises:
an elastomer (E) selected from the group consisting of natural rubber, polybutadienes (BRs), butadiene copolymers, in particular styrene/butadiene copolymers (SBSs), isoprene/butadiene copolymers (BIRs), isoprene/styrene copolymers (SIRs), isoprene/butadiene/styrene copolymers (SBIRs), as well as the functionalised versions thereof,
from 10 to 200 phr, preferably from 50 to 150 phr, more preferably from 60 to 120 phr, of precipitated silica (PS), and
from 0.5 to 40 phr of poly(phenylene sulfide).

The amount of poly(phenylene sulfide) is at least 1 phr, preferably at least 1.5 phr. The amount of poly(phenylene sulfide) is at most 35 phr, preferably at most 30 phr and even at most 20 phr. In some applications advantageous amounts of poly(phenylene sulfide) in composition (C) are from 2 to 15 phr, from 2 to 13 phr and even from 3 to 12 phr.

The poly(phenylene sulfide) has a melt flow rate (at 316° C./5.0 kg) from 100 to 1600 g/10 min.

In an aspect of said first embodiment precipitated silica (PS) is characterised by a BET specific surface area SBET from 45 to 320 m²/g and by a CTAB specific surface area S_{CTAB} from 40 to 300 m²/g.

In a second aspect of said first embodiment precipitated silica (PS) is characterised by a BET specific surface area S_{BET} from 190 to 320 m²/g, a CTAB specific surface area S_{CTAB} from 170 to 300 m²/g, a width of the particle size distribution Ld of at least 0.91, preferably from 1.00 to 2.00; and a pore volume distribution such that the ratio V_{(d5-d50)}/V_{(d5-d100)} is at least 0.65, preferably from 0.65 to 0.75.

In a further aspect of said first embodiment precipitated silica (PS) is characterised by a CTAB specific surface area S_{CTAB} from 60 to 400 m²/g, preferably from 100 to 200 m²/g; a median particle size d50 such that: |d50|>(6214/|S_{CTAB}|)+23; a pore volume distribution such that: V_{(d5-d50)}/V_{(d5-d100)}>0.906−(0.0013×|S_{CTAB}|), and a pore size distribution such that: |Mode|>(4166/|S_{CTAB}|)−9.2.

In a second embodiment of the invention, composition (C) comprises:
an elastomer (E) selected from the group consisting of natural rubber, polybutadienes (BRs), butadiene copolymers, in particular styrene/butadiene copolymers (SBSs), isoprene/butadiene copolymers (BIRs), isoprene/styrene copolymers (SIRs), isoprene/butadiene/styrene copolymers (SBIRs), as well as the functionalised versions thereof,
from 10 to 200 phr, preferably from 50 to 150 phr, more preferably from 60 to 120 phr, of precipitated silica (PS), and
from 0.5 to 40 phr of an aromatic sulfone polymer.

The amount of aromatic sulfone polymer is at least 1 phr, preferably at least 1.5 phr. The amount of aromatic sulfone polymer is at most 35 phr, preferably at most 30 phr and even at most 20 phr.

It is readily understood by those having skill in the art that composition (C), in addition to elastomer (E), silica (S), preferably precipitated silica (PS) and aromatic polymer (A), may comprise various commonly used additive materials such as, for example, sulfur donors, curing aids, such as activators and retarders and processing additives, such as oils, resins including tackifying resins and plasticizers, other reinforcing fillers different from silica (S), pigments, fatty acid, zinc oxide, waxes, antioxidants, coupling agents and the like. As known to those skilled in the art, depending on the intended use of composition (C), the additives mentioned above are selected and commonly used in conventional amounts.

Other Reinforcing Fillers

Notable examples of reinforcing fillers other than silica (S) or precipitated silica (PS) are carbon black, talc, clay, alumina, calcium carbonate, barium sulfate, titanium oxide, and the like.

All carbon blacks, especially blacks of the HAF, ISAF, SAF type, conventionally used in tyres (blacks referred to as tyre grade blacks) are suitable as carbon black. Mention will more particularly be made, among the latter, of the reinforcing carbon blacks of the 100, 200 or 300 series (ASTM grades), such as, for example, the N115, N134, N234, N326, N330, N339, N347 or N375 blacks.

Coupling Agents

Suitable coupling agents to promote the coupling of silica (S) and the optional other inorganic fillers to elastomer (E), are for instance bifunctional coupling agents, in particular bifunctional organosilanes or polyorganosiloxanes.

Use is made in particular of silane polysulfides, referred to as “symmetrical” or “asymmetrical” depending on their specific structure. Particularly suitable, without the definition below being limitative, are so-called “symmetrical” polysulfur-containing silanes which satisfy the following general formula (I): Z-A-Sₙ-A-Z, (I)

in which: n is an integer from 2 to 8 (preferably from 2 to 5); A is a divalent hydrocarbon radical (preferably, C1-C18 alkylene groups or C6-C12 arylene groups, more particularly C1-C10, in particular C1-C4, alkylenes, especially propylene); Z corresponds to one of the formulae below:

SiR₁R₁R₂ or —SiRiR₂R₂ or —SiR₂R₂R₂

in which: the R₁ radicals, which are unsubstituted or substituted and identical to or different from one another, represent a C1-C18 alkyl, C5-C18 cycloalkyl or C6-C18 aryl group (preferably, C1-C6 alkyl, cyclohexyl or phenyl groups, in particular C1-C4 alkyl groups, more particularly methyl and/or ethyl), and the R₂ radicals, which are unsubstituted or substituted and identical to or different from one another, represent a C1-C18 alkoxyl or C5-C18 cycloalkoxyl group (preferably a group chosen from C1-C8alkoxyls and C5-C8 cycloalkoxyls, more preferably still a group chosen from C1-C4 alkoxyls, in particular methoxyl and ethoxyl).

In the case of a mixture of alkoxysilane polysulfides corresponding to the above formula (I), in particular the usual mixtures available commercially, the mean value of the “n” index is a fractional number preferably of between 2 and 5, more preferably in the vicinity of 4.

Mention will more particularly be made, as examples of silane polysulfides, of bis((C1-C4)alkoxyl-(C1-C4)alkyl-silyl-(C1-C4)alkyl)polysulfides (in particular disulfides, trisulfides or tetrasulfides), such as, for example, bis(3-trimethoxysilylpropyl) or bis(3-triethoxysilylpropyl)polysulfides. Use is in particular made, among these compounds, of bis(3-triethoxysilylpropyl)tetrasulfide, abbreviated to TESPT, of formula [(C₂H₅O)₃Si(CH₂)₃S₂]₂, or bis(triethoxysilylpropyl) disulfide, abbreviated to TESPD, of formula [(C₂H₅O)₃Si(CH₂)₃S]₂. Mention will also be made, as preferred examples, of bis(mono(C1-C4)alkoxyldi(C1-C4)alkylsilylpropyl) polysulfides, (in particular disulfides, trisulfides or tetrasulfides), more particularly bis(monoethoxydimethylsilylpropyl) tetrasulfide.

In composition (C) the content of coupling agent is typically between 0.5 and 20 phr, more preferably between 1 and 15 phr.

The coupling agent could be grafted beforehand to the diene elastomer or to silica (S). However, it is preferable, in particular for reasons of better processing of the compositions in the raw state, to use the coupling agent either grafted to silica (S) or in the free state.

Other Additives

Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr.

Typical amounts of tackifier resins, if used, comprise about 0.5 to about 10 phr, usually about 1 to about 5 phr.

Typical amounts of processing aids comprise about 1 to about 50 phr. Typical amounts of antioxidants comprise about 1 to about 5 phr. Representative antioxidants may be, for example, diphenyl-p-phenylenediamine and others.

Typical amounts of fatty acids, if used, which can include stearic acid comprise about 0.5 to about 3 phr. Typical amounts of zinc oxide comprise about 2 to about 5 phr.

Typical amounts of waxes comprise about 1 to about 5 phr. Often microcrystalline waxes are used.

Accelerators are used to control the time and/or temperature required for vulcanization and to improve the properties of the vulcanizate. Typical amounts range from about 0.5 to about 4, alternatively about 0.8 to about 1.5, phr. Suitable types of accelerators that may be used in the present invention are amines, disulfides, guanidines, thioureas, thiazoles, thiurams, sulfenamides, dithiocarbamates and xanthates.

The mixing of the composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage. The terms “non-productive” and “productive” mix stages are well known to those having skill in the rubber mixing art. The composition may be subjected to a thermomechanical mixing step.

In a further object, the present invention provides a process for preparing composition (C) as above defined, said process comprising the following steps:
incorporating into elastomer (E) during a (“non-productive”) first step, the aromatic polymer (A), silica (S), preferably precipitated silica (PS), and the optional other ingredients of the composition with the exception of the sulfur-vulcanizing system, by thermomechanically kneading all ingredients, for example once or several times, until a maximum temperature of between 110° C. and 190° C. is achieved;
cooling the combined mixture.
kneading the mixture to a maximum temperature of less than 110° C.

The process may comprise an additional “productive step” to obtain a cured elastomer composition (CC) comprising the following steps:
providing an elastomer composition (C),
heating elastomer composition (C) to a temperature of less than 100° C.; and
incorporating a sulfur-vulcanizing system.

By way of example, the non-productive phase is carried out in a single thermomechanical step during which all the necessary base constituents, elastomer (E), silica (S) or precipitated silica (PS), aromatic polymer (A) and others, are introduced into an appropriate mixer, such as a standard internal mixer, and kneaded for one to two minutes. Then the other additives, optional additional agents for covering the filler or optional additional processing aids, with the exception of the sulfur-vulcanizing system are added to the mixture and further kneaded. After cooling the mixture thus obtained, the sulfur-vulcanizing system is then incorporated in an external mixer, such as an open mill, maintained at a low temperature (for example between 40° C. and 100° C.). The combined mixture is then mixed (productive phase) for a few minutes, for example between 2 and 15 min.

The final cured composition (CC) thus obtained can subsequently be calendered, for example in the form of a sheet or of a slab, or else extruded.

Elastomer composition (C) has good mechanical properties and improved handling properties.

In a further object, therefore, the present invention provides an article comprising the elastomer composition (C) or the cured composition (CC) derived therefrom, as defined above.

The compositions of the invention may be used for the manufacture of a number of articles. Non-limiting examples of finished articles comprising composition (C), in particular cured composition (CC), are for instance of footwear soles, floor coverings, engineering components, such as rollers for cableways, seals for domestic electrical appliances, seals for liquid or gas pipes, braking system seals, pipes (flexible), sheathings (in particular cable sheathings), cables, engine supports, battery separators, conveyor belts, transmission belts or, preferably, tires. In particular composition (C) may be incorporated in a variety of rubber components of the tire. For example, the rubber component may be a tread (including tread cap and tread base), sidewall, apex, chafer, sidewall insert, wire coat or inner liner. In one embodiment, the compound is a tread.

The invention will be now described with reference to the following examples, whose purpose is merely illustrative and not intended to limit the scope of the invention.

Should the disclosure of any patents, patent applications, and publications which are incorporated herein by reference conflict with the description of the present application to the extent that it may render a term unclear, the present description shall take precedence.

Experimental Part

Raw Materials

PPS: Polyphenylene sulfide, commercially available as Ryton® from Solvay Specialty Polymers USA, LLC (Mₙ 10051; M_{w} 15973).

SBR=Sprintan 6430: Solution polymerized SBR with styrene content of 40% and 1,2-vinyl content of 24% Tg=−36° C. from Styron.

Silica 51=Zeosil® Premium 200MP from Solvay, having : S_{BET} 204 m²/g; S_{CTAB} 190 m²/g.

TESPD: Bis[3-(triethoxysilyl)propyl]disulfide, Xiameter Z-6920 from Dow Corning

N234: Carbon black from Orion

TDAE rubber processing oil:Vivatec 500 from Klauss Dahleke 6PPD: N-(1,3-Dimethylbutyl)-N-phenyl-para-phenylenediamine, Santoflex 6-PPD from Flexsys

DPG: Diphenylguanidine, Rhenogran DPG-80 from RheinChemie

CBS: N-Cyclohexyl-2-benzothiazolesulfenamide, Rhenogran CBS-80 from RheinChemie

### Examples 1-4

### Comparative Examples 1-2

Elastomeric compositions were prepared in an internal mixer of Brabender type (70 mL). The compositions, expressed as parts by weight per 100 parts of elastomers (phr), are described in Table I below:

TABLE I

| | | Comp. | | | | Comp. |
|---|---|---|---|---|---|---|
| Composition | Ex. 1 | Ex. 1 | Ex. 2 | Ex. 3 | Ex. 4 | Ex. 2 |
| SBR | 137.5 | 137.5 | 137.5 | 137.5 | 137.5 | 137.5 |
| Silica S1 | 70 | 70 | 80 | 80 | 80 | 80 |
| PPS | 5 | — | 2 | 5 | 15 | — |
| TESPD | 7 | 7 | 7 | 7 | 7 | 7 |
| Carbon black | 3 | 3 | 3 | 3 | 3 | 3 |
| ZnO | 2.5 | 2.5 | 2.5 | 2.5 | 2.5 | 2.5 |
| Stearic acid | 2 | 2 | 2 | 2 | 2 | 2 |
| 6PPD | 1.2 | 1.2 | 1.2 | 1.2 | 1.2 | 1.2 |
| TDAE oil | 15 | 15 | 5 | 5 | 5 | 5 |
| CBS | 2.1 | 2.1 | 2.1 | 2.1 | 2.1 | 2.1 |
| Sulfur | 1.5 | 1.5 | 1.5 | 1.5 | 1.5 | 1.5 |
| DPG | 1.7 | 1.7 | 1.7 | 1.7 | 1.7 | 1.7 |

Process for the Preparation of the Elastomeric Compositions

The process for the preparation of the elastomeric compositions was carried out in two successive preparation phases: a first phase of high-temperature thermomechanical working, followed by a second phase of mechanical working at temperatures of less than 110° C. to introduce the vulcanization system.

The first, non-productive, phase was carried out using a mixing device, of internal mixer type, of Brabender brand (capacity of 70 mL). The filling coefficient was 0.75. The initial temperature and the speed of the rotors were set at respectively 110rpm and 100° C., rotor speed was adjusted accordingly to follow similar temperature profile and a dropping temperatures of approximately 150-170° C.

In a first pass of the first phase the elastomers and the reinforcing filler (introduction in instalments) were mixed with the coupling agent and all other additives including PPS. The duration was between 4 and 10 minutes.

After cooling the mixture (temperature of less than 100° C.), the vulcanization system (sulfur and accelerators, such as CBS) were added during the second, productive, phase. It was carried out on an open mill, preheated to 50° C. The duration of this phase was between 2 and 6 minutes.

Each final mixture was subsequently calendered in the form of plaques with a thickness of 2-3 mm.

The evaluation of the rheological properties of the “raw” (uncured) mixtures makes it possible to optimize the vulcanization time and the vulcanization temperature.

Subsequently, the mechanical and dynamic properties of the mixtures vulcanized at the curing optimum (T98) were measured.

Rheological Properties

Viscosity of the Raw Mixtures

The Mooney viscosity was measured on the compositions in the raw state at 100° C. using an MV 2000 rheometer. Mooney stress-relaxation rate was according to the standard NF ISO 289.

The value of the torque, read at the end of 4 minutes after preheating for one minute (Mooney Large (1+4)—at 100° C.), is shown in Table II.

The measurements were carried out on the compositions in the raw state.

Rheometry Testing

Rheometry tests were carried out with a D-MDR instrument from MonTech at a temperature of 100° C., at a frequency of 1 Hz with a strain sweep between 0.91% to 50%.

The results are reported in Table II.

TABLE II

| | | Comp. | | | | Comp. |
|---|---|---|---|---|---|---|
| | Ex. 1 | Ex. 1 | Ex. 2 | Ex. 3 | Ex. 4 | Ex. 2 |
| ML (1 + 4) | 103 | 103 | 133 | 136 | 135 | 125 |
| G′1.7% (kPa) | 712 | 716 | 1102 | 1103 | 1390 | 1107 |
| G′14% (kPa) | 402 | 383 | 529 | 533 | 576 | 514 |
| G′50% (kPa) | 202 | 194 | 246 | 252 | 256 | 246 |
| ΔG′ (kPa) | 510 | 522 | 856 | 851 | 1134 | 861 |

The inventive compositions of Examples 1 and 2 to 4 have a Mooney viscosity which is the same or only slightly higher than the viscosity of the compositions that do not contain PPS (Comp. Ex 1 and 2). However, the workability of the inventive compositions during processing is improved.

As shown by the higher values of G'14% and G'50% the compositions tend to be less tacky during the mill operation.

Mechanical Properties of the Vulcanisates

The measurements were carried out on a vulcanized system using the following vulcanization conditions: 170° C. for 15 minutes.

Uniaxial tensile tests were carried out in accordance with the instructions of the standard NF ISO 37 with test specimens of H2 type at a rate of 500 mm/min on an Instron 5564 device. The x% moduli, corresponding to the stress measured at x% of tensile strain, are expressed in MPa.

The ratio of the modulus at 300% strain with the modulus at 100% strain (M300/M100) provides an indication of reinforcement.

The Shore A hardness measurement on the vulcanisates was carried out according to standard ASTM D 2240. The given value was measured at 3 seconds.

The results are collected in Table III.

TABLE III

| | | Comp. | | | | Comp. |
|---|---|---|---|---|---|---|
| | Ex. 1 | Ex. 1 | Ex. 2 | Ex. 3 | Ex. 4 | Ex. 2 |
| Shore A | 56 | 56 | 64 | 66 | 67 | 65 |
| hardness - 3 s | | | | | | |
| 100% Modulus | 1.6 | 1.7 | 2.5 | 2.7 | 2.9 | 2.4 |
| (MPa) | | | | | | |
| 300% Modulus | 7.3 | 7.2 | 11.2 | 11.2 | 10.8 | 10.5 |
| (MPa) | | | | | | |
| M300/M100 | 4.5 | 4.2 | 4.5 | 4.1 | 3.7 | 4.5 |
| Tensile Strength | 22.4 | 20.7 | 25.4 | 23.2 | 21.7 | 26.5 |
| (MPa) | | | | | | |
| Elongation at | 635 | 593 | 536 | 507 | 500 | 580 |
| break (%) | | | | | | |

Determination of the Dynamic Properties of the Vulcanisates

The dynamic properties were measured on a viscosity analyser (Metravib VA3000) according to standard ASTM D5992.

The values for the loss factor (tan δ) and the dynamic strain elastic modulus (G′) were recorded on vulcanized samples (2 mm thick, 1 cm long and 4 mm wide) in double shear mode. Measurement were performed at 40° C. and 1 0Hz frequency, strain between 0.1 to 50%.

In a second set of tests measurement were performed at a variable temperature between −45° C. to 45° C. at a rate of 5° C./min, 1% strain and 10 Hz frequency.

The properties measured are reported in Table IV.

TABLE IV

| | | | Comp. | | | | Comp. |
|---|---|---|---|---|---|---|---|
| | | Ex. 1 | Ex. 1 | Ex. 2 | Ex. 3 | Ex. 4 | Ex. 2 |
| 10 Hz 0.1%-50% | ΔG′ @ 40° C. (MPa) | 1.1 | 1.6 | 2.1 | 3.3 | 3.8 | 2.1 |
| | G*12% @ 40° C. (MPa) | 1.2 | 1.2 | 1.5 | 1.8 | 2.0 | 1.5 |
| | Tanδ 10% @ 40° C. | 0.183 | 0.202 | 0.207 | 0.211 | 0.219 | 0.207 |
| 10 Hz- | Tanδ max | 1.068 | 1.070 | 0.717 | 0.738 | 0.743 | 0.730 |
| 1%- −45 | Tanδ @ 0° C. | 1.066 | 1.068 | 0.708 | 0.710 | 0.730 | 0.714 |
| to 45° C. | G′1% @ 0° C. (MPa) | 22.7 | 22.4 | 20.3 | 20.6 | 21.7 | 19.7 |
| | G′1% @ 40° C. (MPa) | 2.9 | 2.4 | 4.1 | 4.3 | 4.1 | 4.0 |
| | Tanδ @ 40° C. | 0.223 | 0.211 | — | — | — | — |

With respect to the compositions of Comparative Examples 1 and 2 the compositions of Examples 1 to 4 show a better compromise between improved handling and/or wet grip and reduced rolling resistance (higher values tan δ).

1. An elastomer composition (C) comprising:
an elastomer (E),
a sulfur-containing aromatic polymer (A), and
silica (S).

2. The elastomer composition according to claim 1 wherein silica (S) is precipitated silica (PS).

3. The elastomer composition according to claim 2 wherein precipitated silica (PS) is characterised by a BET specific surface area S_{BET} from 45 to 320 m²/g and by a CTAB specific surface area S_{C}TAB from 40 to 300 m²/g.

4. The elastomer composition according to claim 2 wherein precipitated silica (PS) is characterised by a BET specific surface area SBET from 190 to 320 m²/g, a CTAB specific surface area S_{CTAB} from 170 to 300 m²/g, a width of the particle size distribution Ld of at least 0.91; and a pore volume distribution such that the ratio V_{(d5-d50)}/V_{(d5-d100)} is at least 0.65.

5. The elastomer composition according to claim 2 wherein precipitated silica (PS) is characterised by a CTAB specific surface area S_{CTAB} from 60 to 400 m²/g a median particle size d50 such that: |d50|>(6214/|S_{CTAB}+23; a pore volume distribution such that: V_{(d5-d50)}/V_{(d5-d100)}>0.906−(0.0013×S_{CTAB}|), and a pore size distribution such that: |Mode|>(4166/S_{CTAB}|)−9.2.

6. The elastomer composition according to claim 1 anyone of the preceding claims wherein the aromatic polymer (A) is selected from the group consisting of poly(arylene sulfides), preferably poly(phenylene sulfide) (PPS), and aromatic sulfone polymers.

7. The elastomer composition according to claim 1 wherein the aromatic polymer (A) is poly(phenylene sulfide) (PPS).

8. The elastomer composition according to claim 7 wherein the poly(phenylene sulfide) has a melt flow rate, measured at 316° C./5.0 kg, from 100 to 1500 g/10 min.

9. The elastomer composition according to claim 1 wherein aromatic polymer (A) is present in an amount from 0.5 to 50 phr.

10. The elastomer composition according to claim 1 wherein silica (S) is present in an amount from 10 to 200 phr.

11. A process for the preparation of the elastomer composition (C) of claim 1 said process comprising mixing elastomer (E), silica (S), and aromatic polymer (A) in the absence of a sulfur-vulcanizing agent.

12. A process for the preparation of a cured elastomer composition (CC), the process comprising: providing the elastomer composition (C) of claim 1; heating elastomer composition (C) to a temperature of less than 100° C.; and incorporating a sulfur-vulcanizing system.

13. An article comprising the elastomer composition (C) of claim 1.

14. The article of claim 13 which is a footwear sole, a floor covering, a roller for cableways, seal for domestic electrical appliances, seal for liquid or gas pipes, braking system seal, a pipe, a sheathing, such as a cable sheathing, an engine support, a battery separator, a conveyor belt, a transmission belt or a tire.

15. A tire comprising the elastomer composition (C) of claim 1.

16. The elastomer composition according to claim 4 wherein precipitated silica (PS) is characterised by a width of the particle size distribution Ld from 1.00 to 2.00 and a pore volume distribution such that the ratio V_{(d5-d50)}/V_{(d5-d100)} is from 0.65 to 0.75.

17. The elastomer composition according to claim 5 wherein precipitated silica (PS) is characterised by a CTAB specific surface area S_{CTAB} from 100 to 200 m²/g.

18. The elastomer composition according to claim 6 wherein the aromatic polymer (A) is at least one polymer selected from the group consisting of poly(phenylene sulfide) (PPS), polysulfone (PSU) and polyphenylsulfone (PPSU).

19. The elastomer composition according to claim 10 wherein precipitated silica (PS) is present in an amount from 10 to 200 phr.
